(19) United States
(12) Patent Application Publication
(10) Pub. No.: US 2010/0096910 A1
(43) Pub. Date: Apr. 22, 2010

(54) High Rigidity Wheel Rim

(75) Inventors: Blaine Scott Egbert, Lexington, KY (US); Yoshinari Inagaki, Lexington, KY (US)

Correspondence Address: STOLL KEENON OGDEN PLLC, 2000 PNC PLAZA, 500 WEST JEFFERSON STREET, LOUISVILLE, KY, 40202-2828, US

(73) Assignee: Topy America, Inc., Frankfort, KY (US)

(21) Appl. No.: 12/255,053

(22) Filed: Oct. 21, 2008

(51) Int. Cl. B60B 21/10

(52) U.S. Cl. 301/95.107

(57) ABSTRACT

A High Rigidity Wheel Rim is provided comprising a pair of axially spaced radially outward extending annular flanges, an annular well portion intermediate the flanges, and an annular bead seat portion adjacent to each flange and axially spaced from the well portion wherein each bead seat radius is no greater than about 4.5 mm.

### BRIEF DESCRIPTION OF THE DRAWINGS

FIG. 1 is a cross sectional view of a selected portion of a wheel rim showing the standard rim contour measurements used to define the wheel rim.

FIG. 2 is a cross sectional view of a wheel rim according to multiple embodiments and alternatives.

FIG. 3 is a cross sectional view of a wheel rim showing the first annular flange according to multiple embodiments and alternatives.

FIG. 4 is a cross sectional view of a wheel rim showing the second annular flange according to multiple embodiments and alternatives.

FIG. 5 is a graph showing the deformation of the first annular flange in millimeters under a constant static radial load in kilonewtons for an alternative embodiment of the present invention and a prior art wheel rim within the same respective TRA contour category.

FIG. 6 is a graph showing the deformation of the second annular flange in millimeters under a constant static radial load in kilonewtons for an alternative embodiment of the present invention and a prior art wheel rim within the same respective TRA contour category.

FIG. 7 is a graph showing the deformation of the annular well portion in millimeters under a constant static radial load in kilonewtons for an alternative embodiment of the present invention and a prior art wheel rim within the same respective TRA contour category.

### BACKGROUND

Various applications and uses for a High Rigidity Wheel Rim include but are not limited to the following: passenger cars, light trucks and temporary use passenger cars.

Those who work in the industry and field understand that industry organizations set standards governing the contours of wheel rims and that in order to achieve broad industry acceptance, a wheel rim must meet the standards set for a particular category of vehicle wheel approved for that type of vehicle. One such organization is the Tire and Rim Association, Inc (hereinafter “TRA”). Others include the Japan Automobile Tyre Manufacturers Association (hereinafter “JATMA”) and the European Tyre and Rim Technical Organisation (hereinafter “ETRTO”). Furthermore, those who work in the industry and field understand the nomenclature used herein to describe the contours of wheel rims.

Generally, wheel rims include at least one annular well portion and a plurality of annular bead seat portions. Each annular bead seat portion is disposed outward axially from the annular well portion in opposite directions. Wheel rims include a plurality, and most typically two, of annular flanges. There is generally one annular flange disposed in a direction outward axially and extending radially outward from each annular bead seat portion. Each annular flange has a flange edge at the outermost axial edge of each annular flange. Each annular flange may also have a vertical wall extending substantially radially from the annular bead seat portion. Each annular flange has a flange crest at its outermost radial point.

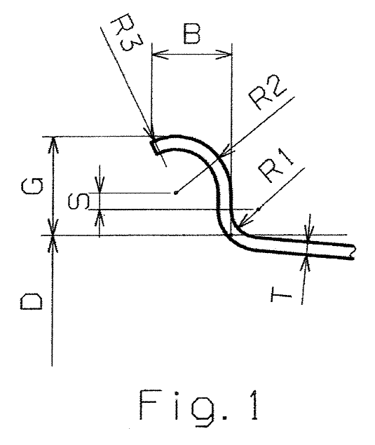

The wheel rim is characterized by a rim diameter D which is the overall diameter of the wheel's annular bead seat portions measured from the intersection of the annular bead seat portion and the vertical wall of the annular flange as shown in FIG. 1.

Those who work in the industry and field understand that wheel rims are characterized by various factors including Standard rim contour measurements. These Standard measurements include Standard rim contour radii, R₁, R₂ and R₃, as shown in FIG. 1. Those who work in the industry and field understand that there are various methods to measure rim contour radii including, but not limited to, the use of radius gages, coordinate measuring machines or the use of profile gages. For example, a radius is measured after locating the center of the arch at the intersection of the perpendicular bisectors of two tangents to the arch. Typically, wheel rims include an annular bead seat bend that corresponds with each annular bead seat portion. Each annular bead seat bend is an annular bend formed between an annular bead seat portion and the neighboring annular flange. Wheel rims have bead seat radii R₁ which are the radii of each annular bead seat bend. Wheel rims also commonly include an annular flange bend that corresponds with each annular flange. Each annular flange bend is an annular bend formed between an annular flange vertical wall and the neighboring flange crest. Wheel rims have flange radii R₂ which are the radii of each annular flange bend. Frequently, wheel rims include an annular flange edge bend that corresponds with each annular flange. Each annular flange edge bend is an annular bend formed between a flange crest and the neighboring flange edge. Wheel rims have flange edge radii R₃ which are the radii of each annular flange edge bend. Each Standard rim contour radii discussed above, R₁, R₂, R₃, respectively, is measured from the respective center to the outer radial surface of the wheel rim as depicted in FIG. 1.

The Standard rim contour measurements also include the measurement of various other dimensions, as shown in FIG. 1. Wheel rims generally have a flange width B which is the axial distance between the outer radial surface of an annular flange vertical wall and the corresponding flange edge. Wheel rims also have a flange height G which is the radial distance between the outer radial surface of a flange crest and the outer radial surface of the corresponding annular bead seat bend at the innermost axial point of the annular bead seat bend curvature. Wheel rims may have a flange straight length S which is the length of the straight section of the annular flange vertical wall. Wheel rims also have a rim thickness T corresponding to the thickness of the material which composes the wheel rim.

### Relevant Industry Standards for All Terrain Vehicles

The TRA and the JATMA Standards for All-Terrain Vehicles (hereinafter “ATV”), 5° Drop Center Rim Contours allow for wheel rim diameters D ranging from 202.4 mm±0.4 mm to 354.8 mm±0.4 mm.

Table 1 illustrates the contour Standards for rim diameter D and flange height G according to the TRA and JATMA ATV Standards. The rim diameter codes distinguish various Standard rim sizes.

TABLE 1

| RIM | | |
|---|---|---|
| DIAMETER | | |
| CODE | D(mm ± 0.4 mm) | G(mm ± 0.5 mm) |
| 8 | 202.4 | 14 |
| 9 | 227.8 | 16 |
| 10 | 253.2 | 16 |
| 11 | 278.6 | 16 |
| 12 | 304.0 | 16 |
| 13 | 329.4 | 16 |
| 14 | 354.8 | 16 |

Additional TRA and JATMA ATV Standards regarding the contour design are as follows:

R₁≦4.5 mm

R₂=6 mm±2 mm

R₃≧3 mm

9 mm≦B≦14 mm

### Relevant Industry Standards for Passenger Cars and Light Trucks

The TRA and JATMA Standards for passenger car and light truck 5° Drop Center Rim “J” Contours allow for wheel rim diameters D ranging from 329.4 mm±0.4 mm to 614.4 mm±0.4 mm.

Table 2 illustrates the TRA and JATMA Standards for rim diameter D according to the relevant passenger car and light truck 5° Drop Center Rim “J” Contours.

TABLE 2

| RIM | |
|---|---|
| DIAMETER | |
| CODE | D(mm ± 0.4 mm) |
| 13 | 329.4 |
| 14 | 354.8 |
| 15 | 380.2 |
| 16 | 405.6 |
| 17 | 436.6 |
| 18 | 462.0 |
| 19 | 487.4 |
| 20 | 512.8 |
| 21 | 538.2 |
| 22 | 563.6 |
| 23 | 589.0 |
| 24 | 614.4 |

Additional TRA and JATMA passenger car and light truck 5° Drop Center Rim “J” Contour Standards regarding the contour design are as follows:

R₁≦6.5 mm

R₂≧9.5 mm

R₃≦R₂, wherein R₃ is optional

B≧11.0 mm

G=17.5mm±1.0 mm

### Relevant Industry Standards for Temporary Use Passenger Cars

The TRA and JATMA Standards for temporary use passenger car tires 5° Drop Center Rim “T” Contours allow for wheel rim diameters D ranging from 329.4 mm±0.4 mm to 462.0 mm±0.4 mm.

Table 3 illustrates the contour Standards for rim diameter D according to the TRA and JATMA temporary use passenger car tires 5° Drop Center Rim “T” Contours.

TABLE 3

| RIM | |
|---|---|
| DIAMETER | |
| CODE | D(mm ± 0.4 mm) |
| 13 | 329.4 |
| 14 | 354.8 |
| 15 | 380.2 |
| 16 | 405.6 |
| 17 | 436.6 |
| 18 | 462.0 |

Additional TRA and JATMA temporary use passenger car tires 5° Drop Center Rim “T” Contour Standards regarding the contour design are as follows:

R₁≦6.4 mm

R₂=8.9 mm

R₃=6.4 mm

B≧10.9 mm

G=18.0 mm±0.7 mm

ATV wheel rims do not meet the Standards for use on passenger cars and light trucks or the Standards for temporary use on passenger cars. ATV wheels are not designed for use on roadways; they do not meet the statutory requirements of the Federal Motor Vehicle Safety Standards. ATV wheels are designed to accommodate ATV tires which operate at significantly slower speeds than passenger car and light truck tires. For example, the maximum design speed for ATV tires is 80 km/h. In contrast, the minimum design speed is 160 km/h for passenger car tires and 140 km/h for light truck tires. The design speed for temporary use passenger car tires is 130 km/h.

In addition, ATV wheels are designed to support less weight than wheels suitable for passenger cars and light trucks. ATV tires operate at a significantly lower air pressure than passenger car and light truck tires. ATV wheels are designed to support tires inflated to a maximum air pressure of about 45 kPa. In contrast, 5° Drop Center Rim “J” Contour passenger car wheels are designed to support tires inflated to an air pressure between about 180 kPa and about 250 kPa. 5° Drop Center Rim “J” Contour light truck wheels are designed to support tires inflated to an air pressure between about 250 kPa and about 450 kPa. 5° Drop Center Rim “T” Contour temporary use passenger car wheels are designed to support tires inflated to a maximum air pressure of about 420 kPa.

### MULTIPLE EMBODIMENTS AND ALTERNATIVES

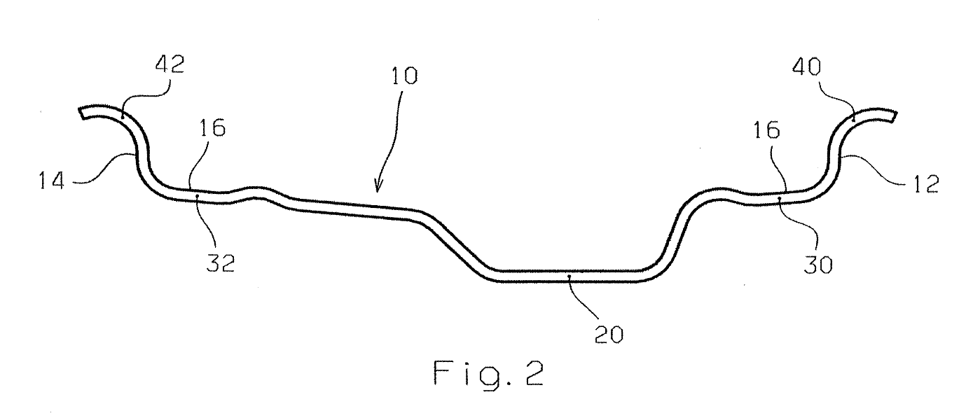

Multiple embodiments and alternatives are provided for a High Rigidity Wheel Rim including the wheel rim 10 as shown generally in FIG. 2. The wheel rim 10 includes at least one annular well portion 20. Embodiments of the wheel rim 10 include a first annular bead seat portion 30 and a second annular bead seat portion 32. Alternatives include those wherein the first annular bead seat portion 30 is substantially identical to the second annular bead seat portion 32. As desired, the first annular bead seat portion 30 and the second annular bead seat portion 32 are disposed outward axially from the annular well portion 20 in opposite directions, thereby providing a pair of annular bead seat portions 30, 32.

As shown in FIG. 2, and in further detail, the wheel rim 10 includes, as desired, a first annular flange 40 and a second annular flange 42. In some embodiments, the first annular flange 40 is substantially identical to the second annular flange 42. The first annular flange 40 is disposed in a direction outward axially from the first annular bead seat portion 30 and extends radially outward from the first annular bead seat portion 30. The second annular flange 42 is disposed in a direction outward axially from the second annular bead seat portion 32 and extends radially outward from the second annular bead seat portion 32. Embodiments provide that the first annular flange 40 is disposed on an axially outboard side 12 of the wheel rim 10, and the second annular flange 42 is disposed on an axially inboard side 14 of the wheel rim 10.

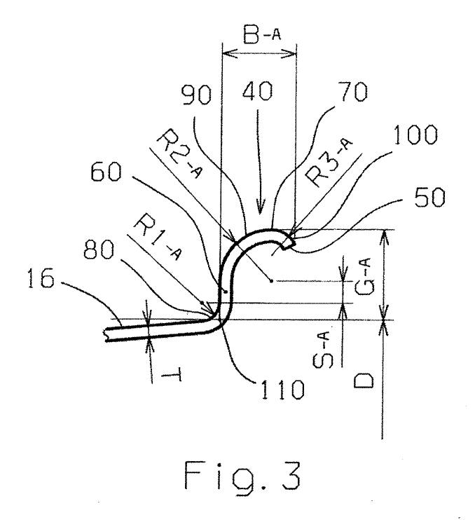

With reference to FIG. 3, multiple embodiments include the first annular flanges 40, and as desired, the first annular flange 40 has a first flange edge 50 at the outermost axial edge of the first annular flange 40. The first annular flange 40 has a first vertical wall 60 extending substantially radially from the first annular bead seat portion 30. In multiple embodiments, the first annular flange 40 has a first flange crest 70 at the outermost radial point of the first annular flange 40.

Multiple embodiments of the wheel rim 10 include a first annular bead seat bend 80. The first annular bead seat bend 80 is the annular bend formed between the first annular bead seat portion 30 and the first annular flange 40. The wheel rim 10 has a first bead seat radius R_{1-A}. The first bead seat radius R_{1-A} is the radius of the first annular bead seat bend 80 measured from the outer radial surface 16 of the wheel rim 10.

Going on, a first flange radius is provided as follows. The wheel rim 10 includes a first annular flange bend 90. The first annular flange bend 90 is the annular bend formed between the first vertical wall 60 and the first flange crest 70. The wheel rim 10 has a first flange radius R_{2-A}. The first flange radius R_{2-A} is the radius of the first annular flange bend 90 measured from the outer radial surface 16 of the wheel rim 10.

A first flange edge radius is provided as follows. With continued reference to FIG. 3, the wheel rim 10 includes a first annular flange edge bend 100. The first annular flange edge bend 100 is the annular bend formed between the first flange crest 70 and the first flange edge 50. The wheel rim 10 has a first flange edge radius R_{3-A}. The first flange edge radius R_{3-A} is the radius of the first annular flange edge bend 100 measured from the outer radial surface 16 of the wheel rim 10.

A first flange width is provided as follows. The wheel rim 10 has a first flange width B_{A} which is the axial distance between the outer radial surface 16 of the first vertical wall 60 and the first flange edge 50.

A first flange height is provided as follows. The wheel rim 10 has a first flange height G_{A} which is the radial distance between the outer radial surface 16 of the first flange crest 70 and the outer radial surface 16 of the first annular bead seat bend 80 at the innermost axial point of the annular bead seat bend 80 curvature.

A first flange straight length is provided as follows. The wheel rim 10 has a first flange straight length S_{A} which is the length of the straight section of the first vertical wall 60.

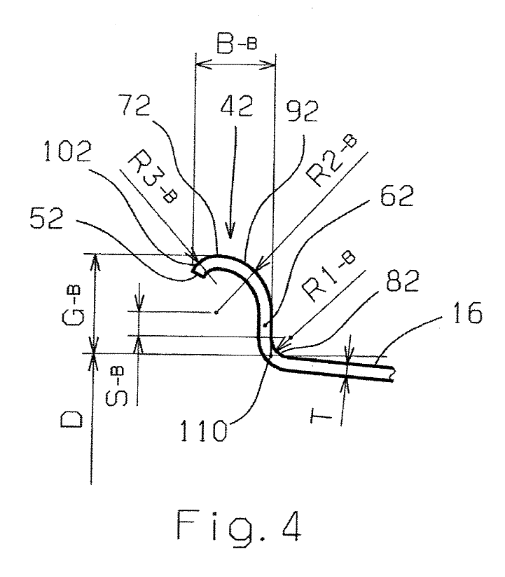

With reference to FIG. 4, multiple embodiments include the second annular flanges 42, and as desired, the second annular flange 42 has a second flange edge 52 at the outermost axial edge of the second annular flange 42. The second annular flange 42 has a second vertical wall 62 extending substantially radially from the second annular bead seat portion 32. In multiple embodiments, the second annular flange 42 has a second flange crest 72 at the outermost radial point of the second annular flange 42.

Multiple embodiments of the wheel rim 10 include a second annular bead seat bend 82. The second annular bead seat bend 82 is the annular bend formed between the second annular bead seat portion 32 and the second annular flange 42. The wheel rim 10 has a second bead seat radius R_{1-B}. The second bead seat radius R_{1-B} is the radius of the second annular bead seat bend 82 measured from the outer radial surface 16 of the wheel rim 10. Alternatives include those wherein the first bead seat radius R_{1-A} is substantially equal to the second bead seat radius R_{1-B}.

A second flange radius is provided as follows. The wheel rim 10 includes a second annular flange bend 92. The second annular flange bend 92 is an annular bend formed between the second vertical wall 62 and the second flange crest 72. The wheel rim 10 has a second flange radius R_{2-B}. The second flange radius R_{2-B} is the radius of the second annular flange bend 92 measured from the outer radial surface 16 of the wheel rim 10. In some embodiments, the first flange radius R_{2-A} is substantially equal to the second flange radius R_{2-B}.

A second flange edge radius is provided as follows. With continued reference to FIG. 4, the wheel rim 10 includes a second annular flange edge bend 102. The second annular flange edge bend 102 is an annular bend formed between the second flange crest 72 and the second flange edge 52. The wheel rim 10 has a second flange edge radius R_{3-B} which is the radius of the second annular flange edge bend 102 measured from the outer radial surface 16 of the wheel rim 10. As desired, the first flange edge radius R_{3-A} is substantially equal to the second flange edge radius R_{3-B}.

A second flange width is provided as follows. The wheel rim 10 has a second flange width B_{B} which is the axial distance between the outer radial surface 16 of the second vertical wall 62 and the second flange edge 52. Embodiments include those wherein the first flange width B_{A} is substantially equal to the second flange width B_{B}.

A second flange height is provided as follows. The wheel rim 10 has a second flange height G_{B} which is the radial distance between the outer radial surface 16 of the second flange crest 72 and the outer radial surface 16 of the second annular bead seat bend 82 at the innermost axial point of the annular bead seat bend 82 curvature. Embodiments provide that the first flange height G_{A} is substantially equal to the second flange height G_{B}.

A second flange straight length is provided as follows. The wheel rim 10 has a second flange straight length S_{B} which is the length of the straight section of the second vertical wall 62. Alternatives include those wherein the first flange straight length S_{A} is substantially equal to the second flange straight length S_{B}.

Referring to FIGS. 3 and 4, the wheel rim 10 has a rim diameter D which is the overall diameter of the wheel's annular bead seat portions 30, 32 measured from the intersection 110 of the annular bead seat portion 30, 32 and the vertical wall 60, 62 of the annular flange 40, 42. The wheel rim 10 has a rim thickness T which is the radial thickness of the material which composes the wheel rim 10.

In combining such factors, various embodiments and alternatives are provided. For example, not meant to be limiting, the first bead seat radius R_{1-A} and the second bead seat radius R_{1-B} are no greater than about 4.5 mm. Multiple embodiments of the wheel rim 10 utilize a first bead seat radius R_{1-A} and a second bead seat radius R_{1-B} as found on at least some existing ATV wheel rims; but the bead seat radii R_{1-A} and R_{1-B} of the wheel rim 10 represent a reduction from the prior art 5° Drop Center Rim “J” and “T” bead seat radii of about 6.5 mm and yet allowing standards-meeting use of wheel rim 10 on passenger cars and light trucks.

Similarly, embodiments include those wherein the wheel rim 10 includes a rim diameter D that is greater than the rim diameter D on existing ATV wheel rims. Embodiments provide that the first flange height G_{A} and the second flange height G_{B} that are greater than the first flange height G_{A} and the second flange height G_{B} on existing ATV wheel rims. As desired, the first flange radius R_{2-A} and the second flange radius R_{2-B} that are greater than the first flange radius R_{2-A} and the second flange radius R_{2-B} on existing ATV wheel rims. In some embodiments, the first flange width B_{A} and the second flange width B_{B} of the wheel rim 10 are greater than the first flange width B_{A} and the second flange width B_{B} on at least some existing ATV wheel rims. Alternatives include those wherein the wheel rim 10 complies with the 5° Drop Center Rim “J” Contour Standards and are suitable for use on passenger cars or light trucks and those wherein the wheel rim 10 complies with the 5° Drop Center Rim “T” Contour Standards and are suitable for temporary use on passenger cars.

Some embodiments of the wheel rim 10 comply with the requirements for 5° Drop Center Rim “J” Contour passenger cars in order to accommodate passenger car tires and some embodiments of the wheel rim 10 comply with the requirements for 5° Drop Center Rim “J” Contour light trucks in order to accommodate light truck tires. Some embodiments of the wheel rim 10 comply with the requirements for 5° Drop Center Rim “T” Contour temporary use passenger cars in order to accommodate temporary use passenger car tires.

Those who work in the industry and field understand the use of dynamic (impact) load testing. The dynamic load tests of multiple embodiments of the wheel rim 10 indicate that the rim rigidity as indicated by the deformation amount improves significantly in the areas of both the first annular flange 40 and the second annular flange 42 as compared to prior art wheel rims within the same respective TRA contour category. For example, Table 4 illustrates the deformation amount under a constant static load for an alternative embodiment of the wheel rim 10 compared with a prior art wheel rim within the same respective TRA contour category.

TABLE 4

| | Deformation (mm) | | | | | |
|---|---|---|---|---|---|---|
| | | | Second Annular Flange | | Annular Well Portion | |
| | First Annular Flange 40 | | 42 | | 20 | |
| | | An | | An | | An |
| | | Alternative | | Alternative | | Alternative |
| Radial | Prior Art | Embodiment | Prior Art | Embodiment | Prior Art | Embodiment |
| Load | Wheel | of Wheel | Wheel | of Wheel | Wheel | of Wheel |
| (kN) | Rim | Rim 10 | Rim | Rim 10 | Rim | Rim 10 |
| 20.0 | 0.113 | 0.060 | 0.137 | 0.097 | 0.040 | 0.047 |
| 22.5 | 0.237 | 0.123 | 0.230 | 0.153 | 0.040 | 0.057 |
| 25.0 | 0.507 | 0.237 | 0.393 | 0.220 | 0.060 | 0.060 |
| 27.5 | 1.023 | 0.440 | 0.703 | 0.323 | 0.083 | 0.070 |
| 30.0 | 2.553 | 0.833 | 1.687 | 0.533 | 0.143 | 0.093 |
| 32.5 | 6.817 | 1.530 | 4.110 | 0.837 | 0.287 | 0.117 |
| 35.0 | 17.663 | 3.320 | 8.900 | 1.597 | 0.550 | 0.197 |
| 37.5 | (air leak) | 10.030 | (air leak) | 4.653 | (air leak) | 0.420 |
| 40.0 | | 20.725 | | 8.665 | | 0.785 |
| 42.5 | | (air leak) | | (air leak) | | (air leak) |

As shown in Table 4, embodiments of the wheel rim 10 provide increased resistance to air leaks with regard to the application of static radial loads.

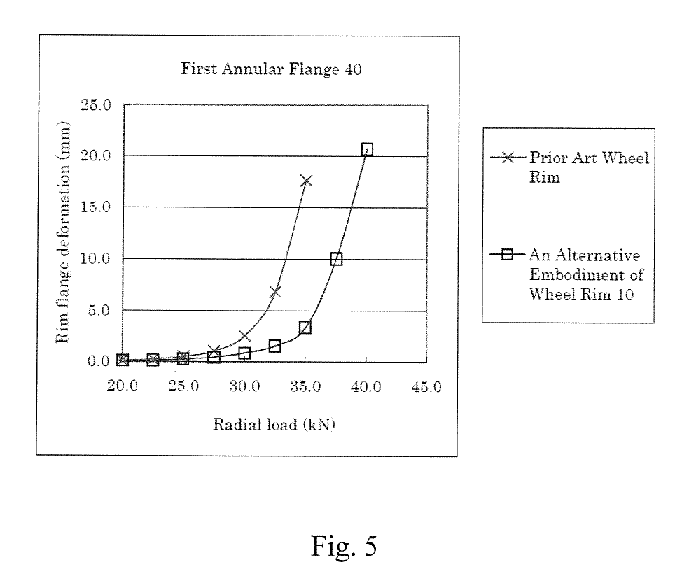

With reference to FIG. 5, FIG. 5 illustrates the data shown in Table 4 related to the deformation of the first annular flange 40 under a constant static load for an alternative embodiment of the wheel rim 10 compared with a prior art wheel rim within the same respective TRA contour category as shown in Table 4.

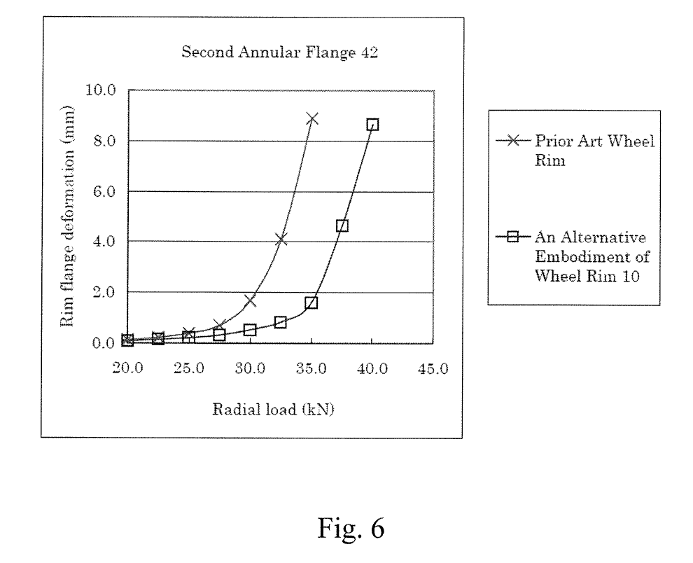

With reference to FIG. 6, FIG. 6 illustrates the data shown in Table 4 related to the deformation of the second annular flange 42 under a constant static load for an alternative embodiment of the wheel rim 10 compared with a prior art wheel rim within the same respective TRA contour category as shown in Table 4.

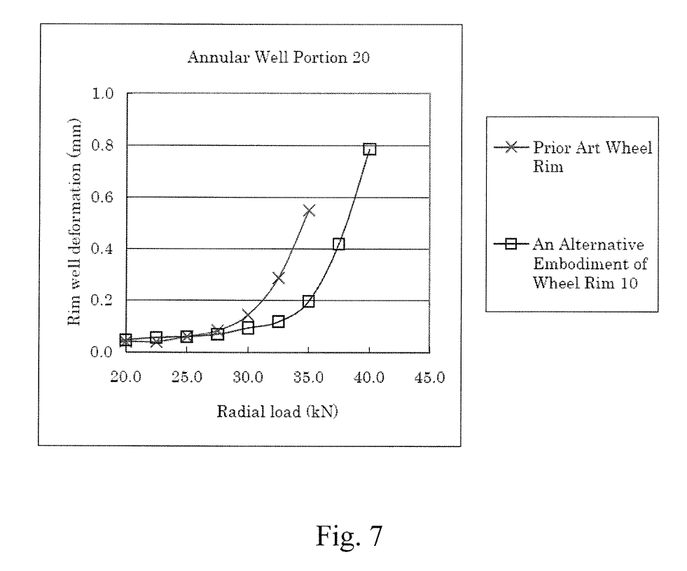

With reference to FIG. 7, FIG. 7 illustrates the data shown in Table 4 related to the deformation of the annular well portion 20 under a constant static load for an alternative embodiment of the wheel rim 10 compared with a prior art wheel rim within the same respective TRA contour category.

The high rigidity makes it possible for multiple embodiments of the wheel rim 10 to use a material with a lower tensile strength than prior art wheel rims within the same respective TRA contour category while still achieving substantially the same rim rigidity as same contour category prior art wheel rims. Embodiments of the wheel rim 10 include those composed of a material with lower tensile strength generally cost less to produce than same contour category prior art wheel rims composed of a material with a higher tensile strength, wherein rim thickness T is held constant, while meeting industry Standards for rigidity. The high rigidity also makes it possible for multiple embodiments of the wheel rim 10 to include decreased rim thickness T as compared to prior art wheel rims within the same respective TRA contour category while still achieving substantially the same rim rigidity as same contour category prior art wheel rims. Embodiments of the wheel rim 10 that decrease the rim thickness T create a lighter wheel than same contour category wheel rims, wherein material properties are held constant, while meeting industry Standards for rigidity. These lighter wheels generally result in greater fuel economy. Some embodiments of the wheel rim 10 utilize both a material with a lower tensile strength and a thinner material than same contour category prior art wheel rims.

Wheel rims are known to occasionally exhibit problems in retaining wheel weights affixed to their outer periphery. Embodiments of the wheel rim 10 provide that the balance weight retention force of the wheel rim 10 meets or exceeds that of prior art wheels. Additionally, design of the multiple embodiments of the wheel rim 10 reduces the risk of either the first flange edge 50 or the second flange edge 52 damaging the bead area of a tire (not shown).

Multiple embodiments of the wheel rim 10 include rim diameters D ranging from 329.4 mm±0.4 mm to 614.4 mm±0.4 mm. These rim diameters D correspond with rim diameter codes ranging from 13 to 24.

Multiple embodiments of the wheel rim 10 are formed from flat sheet metal. Embodiments include the wheel rim 10 composed substantially of steel or steel alloys wherein the steel or steel alloys are of any suitable tensile strength. Alternatives include the wheel rim 10 composed substantially of titanium or titanium alloys. In other embodiments, the wheel rim 10 is composed substantially of aluminum or aluminum alloys. As desired, the wheel rim 10 is composed substantially of magnesium or magnesium alloys but the wheel rim 10 may be composed of any suitable material.

Embodiments of the wheel rim 10 include those where each bead seat radius R_{1-A}, R_{1-B} is no greater than about 4.5 mm. In some embodiments, each bead seat radius R_{1-A}, R_{1-B} is greater than the rim thickness T.

In multiple embodiments of the wheel rim 10, each flange radius R_{2-A}, R_{2-B} is at least about 8 mm but each flange radius R_{2-A}, R_{2-B} may be any suitable length.

As desired, each flange edge radius R_{3-A}, R_{3-B} is less than the adjacent flange radius R_{2-A}, R_{2-B}. Alternatives includes those wherein the ratio of the first flange edge radius R_{3-A} to the first flange radius R_{2-A} is no greater than a ratio of about 3:4. The ratio of the second flange edge radius R_{3-B} to the second flange radius R_{2-B} is no greater than a ratio of about 3:4. In some embodiments, each flange edge radius R_{3-A}, R_{3-B} is between about 6 mm and about 7 mm but each flange edge radius R_{3-A}, R_{3-B} may be any suitable length.

Embodiments include those wherein each flange width B_{A}, B_{B} is greater than about 10.9 mm. In some embodiments, each flange width B_{A}, B_{B} is equal to the sum of the adjacent flange radius R_{2-A}, R_{2-B} and the adjacent flange edge radius R_{3-A}, R_{3-B}, ±about 1.5 mm, but each flange width B_{A}, B_{B} may be any suitable length.

Embodiments provide that each flange height G_{A}, G_{B} is between about 16.5 mm and about 18.7 mm but each flange height G_{A}, G_{B} may be any suitable length.

In multiple embodiments, each flange straight length S_{A}, S_{B} is at least about 3.5 mm but each flange straight length S_{A}, S_{B} may be any suitable length.

It will therefore be readily understood by those persons skilled in the art that the embodiments and alternatives of a High Rigidity Wheel Rim are susceptible of a broad utility and application. While the embodiments are described in all currently foreseeable alternatives, there may be other, unforeseeable embodiments and alternatives, as well as variations, modifications and equivalent arrangements that do not depart from the substance or scope of the embodiments. The foregoing disclosure is not intended to be construed to limit the embodiments or otherwise to exclude such other embodiments, adaptations, variations, modifications and equivalent arrangements, the embodiments being limited only by the claims appended hereto and the equivalents thereof.

We claim:

1. A wheel rim comprising:
a first annular flange,
a second annular flange,
a first annular bead seat portion,
a second annular bead seat portion,
an annular well portion,
a first annular bead seat bend,
and a second annular bead seat bend;
wherein the first bead seat portion and the second bead seat portion are disposed outward axially from the annular well portion in opposite directions;
the first annular flange is disposed in a direction outward axially from the first annular bead seat portion and extends radially outward from the first annular bead seat portion;
the second annular flange is disposed in a direction outward axially from the second annular bead seat portion and extends radially outward from the second annular bead seat portion;
the first annular bead seat bend is the annular bend formed between the first annular bead seat portion and the vertical wall of the first annular flange;
and the second annular bead seat bend is the annular bend formed between the second annular bead seat portion and the vertical wall of the second annular flange;
wherein the first annular bead seat bend has a first bead seat radius R_{1-A};
the second annular bead seat bend has a second bead seat radius R_{1-B};
the first bead seat radius R₁₋_{A} is no greater than about 4.5 mm;
the second bead seat radius R_{1-B} is no greater than about 4.5 mm;
and the rim diameter D is greater than 355.2 mm.

2. The wheel rim of claim 1 wherein the first bead seat radius R_{1-A} and the second bead seat radius R_{1-B} are substantially equal.

3. The wheel rim of claim 1 wherein the wheel rim is formed from flat sheet metal.

4. The wheel rim of claim 3 wherein the wheel rim is composed substantially of a material chosen from the group titanium, titanium alloy, steel and steel alloy.

5. The wheel rim of claim 1 wherein:
the wheel rim has a rim thickness T;
the first bead seat radius R_{1-A} is greater than the rim thickness T;
and the second bead seat radius R_{1-B} is greater than the rim thickness T.

6. A wheel rim comprising:
a first annular flange,
a second annular flange,
a first annular bead seat portion,
a second annular bead seat portion,
an annular well portion,
a first annular bead seat bend,
a second annular bead seat bend,
a first annular flange bend,
and a second annular flange bend;
wherein the first bead seat portion and the second bead seat portion are disposed outward axially from the annular well portion in opposite directions;
the first annular flange is disposed in a direction outward axially from the first annular bead seat portion and extends radially outward from the first annular bead seat portion;
the second annular flange is disposed in a direction outward axially from the second annular bead seat portion and extends radially outward from the second annular bead seat portion;
the first annular bead seat bend is the annular bend formed between the first annular bead seat portion and the vertical wall of the first annular flange;
and the second annular bead seat bend is the annular bend formed between the second annular bead seat portion and the vertical wall of the second annular flange;
wherein the first annular bead seat bend has a first bead seat radius R_{1-A};
the second annular bead seat bend has a second bead seat radius R_{1-B};
the first annular flange bend has a first flange radius R_{2-A};
the second annular flange bend has a second flange radius R_{2-B};
the first annular flange has a first flange height G_{A};
and the second annular flange has a second flange height G_{B};
wherein the first bead seat radius R_{1-A} is no greater than about 4.5 mm;
the second bead seat radius R_{1-B} is no greater than about 4.5 mm;
the first flange radius R_{2-A} is at least about 8 mm;
the second flange radius R_{2-B} is at least about 8 mm;
the first flange height G_{A} is between about 16.5 mm and about 18.7 mm;
and the second flange height G_{B} is between about 16.5 mm and about 18.7 mm.

7. The wheel rim of claim 6 wherein the first bead seat radius R_{1-A} and the second bead seat radius R_{1-B} are substantially equal.

8. The wheel rim of claim 7 wherein the first flange radius R_{2-A} and the second flange radius R_{2-B} are substantially equal.

9. The wheel rim of claim 8 wherein the first flange height G_{A} and the second flange height G_{B} are substantially equal.

10. The wheel rim of claim 6 wherein the wheel rim is formed from flat sheet metal.

11. The wheel rim of claim 10 wherein the wheel rim is composed substantially of a material chosen from the group titanium, titanium alloy, steel and steel alloy.

12. The wheel rim of claim 6 wherein:
the wheel rim has a rim thickness T;
the first bead seat radius R_{1-A} is greater than the rim thickness T;
and the second bead seat radius R_{1-B} is greater than the rim thickness T.

13. The wheel rim of claim 6 wherein:
the first flange radius R_{2-A} is at least about 9.5 mm;
the second flange radius R_{2-B} is at least about 9.5 mm;
the first flange height G_{A} is between about 16.5 mm and about 18.5 mm;
and the second flange height G_{B} is between about 16.5 mm and about 18.5 mm.

14. The wheel rim of claim 13 further comprising:
a first annular flange edge bend,
and a second annular flange edge bend;
wherein the first annular flange edge bend has a first flange edge radius R_{3-A};
the second annular flange edge bend has a second flange edge radius R_{3-B};
the first annular flange has a first flange width B_{A};
the second annular flange has a second flange width B_{B};
the first annular flange has a first flange straight length S_{A};
and the second annular flange has a second straight length S_{B};
wherein the ratio of the first flange edge radius R_{3-A} to the first flange radius R_{2-A} is no greater than about 3:4;
the ratio of the second flange edge radius R_{3-B} to the second flange radius R_{2-B} is no greater than about 3:4;
the first flange width B_{A} is equal to the sum of the first flange radius R_{2-A} and the first flange edge radius R_{3-A}, ±about 1.5 mm;
the second flange width B_{B} is equal to the sum of the second flange radius R_{2-B} and the second flange edge radius R_{3-B}, ±about 1.5 mm;
the first flange straight length S_{A} is at least about 3.5 mm;
and the second flange straight length S_{B} is at least about 3.5 mm.

15. The wheel rim of claim 6 wherein:
the first flange radius R_{2-A} is at least about 8.9 mm;
the second flange radius R_{2-B} is at least about 8.9 mm;
the first flange height G_{A} is between about 17.3 mm and about 18.7 mm;
and the second flange height G_{B} is between about 17.3 mm and about 18.7 mm.

16. The wheel rim of claim 15 further comprising:
a first annular flange edge bend;
and a second annular flange edge bend;
wherein the first annular flange edge bend has a first flange edge radius R_{3-A};
the second annular flange edge bend has a second flange edge radius R_{3-B};
the first annular flange has a first flange width B_{A};
the second annular flange has a second flange width B_{B};
the first annular flange has a first flange straight length S_{A};
and the second annular flange has a second straight length S_{B};
wherein the first flange width B_{A} is equal to the sum of the first flange radius R_{2-A} and the first flange edge radius R_{3-A}, ±about 1.5 mm;
the second flange width B_{B} is equal to the sum of the second flange radius R_{2-B} and the second flange edge radius R_{3-B}, ±about 1.5 mm;
the first flange straight length S_{A} is at least about 4.5 mm;
and the second flange straight length S_{B} is at least about 4.5 mm.

17. A wheel rim comprising:
a first annular flange,
a second annular flange,
a first annular bead seat portion,
a second annular bead seat portion,
an annular well portion,
a first annular bead seat bend,
and a second annular bead seat bend,
wherein the first bead seat portion and the second bead seat portion are disposed outward axially from the annular well portion in opposite directions;
the first annular flange is disposed in a direction outward axially from the first annular bead seat portion and extends radially outward from the first annular bead seat portion;
the second annular flange is disposed in a direction outward axially from the second annular bead seat portion and extends radially outward from the second annular bead seat portion;
the first annular bead seat bend is the annular bend formed between the first annular bead seat portion and the vertical wall of the first annular flange;
and the second annular bead seat bend is the annular bend formed between the second annular bead seat portion and the vertical wall of the second annular flange;
wherein the first annular bead seat bend has a first bead seat radius R_{1-A};
and the second annular bead seat bend has a second bead seat radius R_{1-B};
wherein the first bead seat radius R_{1-A} is no greater than about 4.5 mm;
the second bead seat radius R_{1-B} is no greater than about 4.5 mm;
and the wheel rim is disposed on a vehicle other than an all-terrain vehicle.

18. An improvement to a wheel rim, the improvement comprising:
a first annular flange,
a second annular flange,
a first annular bead seat portion,
a second annular bead seat portion,
an annular well portion,
a first annular bead seat bend,
and a second annular bead seat bend;
wherein the first bead seat portion and the second bead seat portion are disposed outward axially from the annular well portion in opposite directions;
the first annular flange is disposed in a direction outward axially from the first annular bead seat portion and extends radially outward from the first annular bead seat portion;
the second annular flange is disposed in a direction outward axially from the second annular bead seat portion and extends radially outward from the second annular bead seat portion;
the first annular bead seat bend is the annular bend formed between the first annular bead seat portion and the vertical wall of the first annular flange;
and the second annular bead seat bend is the annular bend formed between the second annular bead seat portion and the vertical wall of the second annular flange;
wherein the first annular bead seat bend has a first bead seat radius R_{1-A};
the second annular bead seat bend has a second bead seat radius R_{1-B};
the first bead seat radius R_{1-A} is no greater than about 4.5 mm;
the second bead seat radius R_{1-B} is no greater than about 4.5 mm;
and a rim diameter D greater than 355.2 mm.

19. The wheel rim of claim 18 wherein the first bead seat radius R_{1-A} and the second bead seat radius R_{1-B} are substantially equal.

20. An improvement to a wheel rim, the improvement comprising:
a first annular flange,
a second annular flange,
a first annular bead seat portion,
a second annular bead seat portion,
an annular well portion,
a first annular bead seat bend,
a second annular bead seat bend,
a first annular flange bend,
and a second annular flange bend;
wherein the first bead seat portion and the second bead seat portion are disposed outward axially from the annular well portion in opposite directions;
the first annular flange is disposed in a direction outward axially from the first annular bead seat portion and extends radially outward from the first annular bead seat portion;
the second annular flange is disposed in a direction outward axially from the second annular bead seat portion and extends radially outward from the second annular bead seat portion;
the first annular bead seat bend is the annular bend formed between the first annular bead seat portion and the vertical wall of the first annular flange;
and the second annular bead seat bend is the annular bend formed between the second annular bead seat portion and the vertical wall of the second annular flange;
wherein the first annular bead seat bend has a first bead seat radius R_{1-A};
the second annular bead seat bend has a second bead seat radius R_{1-B};
the first annular flange bend has a first flange radius R_{2-A};
the second annular flange bend has a second flange radius R_{2-B};
the first annular flange has a first flange height G_{A};
and the second annular flange has a second flange height G_{B};
wherein the first bead seat radius R_{1-A} is no greater than about 4.5 mm;
the second bead seat radius R_{1-B} is no greater than about 4.5 mm;
the first flange radius R_{2-A} is at least about 8 mm;
the second flange radius R_{2-B} is at least about 8 mm;
the first flange height G_{A} is between about 16.5 mm and about 18.7 mm;
and the second flange height G_{B} is between about 16.5 mm and about 18.7 mm.

21. The wheel rim of claim 20 wherein the first bead seat radius R_{1-A} and the second bead seat radius R_{1-B} are substantially equal.

22. The wheel rim of claim 20 wherein the improvement further comprises:
a first flange edge radius R_{3-A} and a first flange radius R_{2-A} having a ratio R_{3-A}:R_{2-A} no greater than about 3:4;
a second flange edge radius R_{3-A} and a second flange radius R_{2-A} having a ratio R_{3-A}:R_{2-A} no greater than about 3:4;
a first flange width B_{A} equal to the sum of the first flange radius R_{2-A} and the first flange edge radius R_{3-A}, ±about 1.5 mm;
a second flange width B_{B} equal to the sum of the second flange radius R_{2-B} and the second flange edge radius R_{3-B}, ±about 1.5 mm;
a first flange straight length S_{A} that is at least about 3.5 mm;
and a second flange straight length S_{B} that is at least about 3.5 mm.

23. The wheel rim of claim 20 wherein the improvement further comprises:
a first flange width B_{A} equal to the sum of the first flange radius R_{2-A} and the first flange edge radius R_{3-A}, ±about 1.5 mm;
a second flange width B_{B} equal to the sum of the second flange radius R_{2-B} and the second flange edge radius R_{3-B}, ±about 1.5 mm;
a first flange straight length S_{A} that is at least about 4.5 mm;
and a second flange straight length S_{B} that is at least about 4.5 mm.
